(19) United States
(12) Patent Application Publication
(10) Pub. No.: US 2025/0370774 A1
(43) Pub. Date: Dec. 4, 2025

(54) CLOUD SERVER THAT PROVIDES IN-VEHICLE INFOTAINMENT AND METHOD OF PROVIDING IN-VEHICLE INFOTAINMENT USING THE SAME

(71) Applicants: Hyundai Motor Company, Seoul (KR); Kia Corporation, Seoul (KR)

(72) Inventors: Yunjoong Park, Hwaseong-si (KR); Jeongtaek Oh, Hwaseong-si (KR)

(21) Appl. No.: 18/946,370

(22) Filed: Nov. 13, 2024

(30) Foreign Application Priority Data
May 28, 2024 (KR) 10-2024-0069187

(51) Int. Cl. G06F 9/451; B60K 35/28; B60K 35/65

(52) U.S. Cl. CPC G06F 9/451; B60K 35/28; B60K 35/65; B60K 2360/164; B60K 2360/592; B60K 2360/731

(57) ABSTRACT

A cloud server that provides in-vehicle infotainment can include a virtual instance generated using a user account received from an in-vehicle infotainment (IVI) system installed in a vehicle, and when an on operation for starting the vehicle is detected by the IVI system, a cloud manager of the cloud server can be configured to receive information on the user account from the IVI system, search for the virtual instance including the user information matching user information included in the user account, transmit an application list included in the searched virtual instance to the IVI system, receive application selection information specifying at least one application among a plurality of applications included in the application list from the IVI system, execute an application corresponding to the application selection information using the searched virtual instance, and transmit an execution screen of the application to the IVI system.

### CROSS-REFERENCE TO RELATED APPLICATIONS

This application claims priority to and the benefit of Korean Patent Application No. 10-2024-0069187 filed in the Korean Intellectual Property Office on May 28, 2024, the entire contents of which are incorporated herein by reference.

### TECHNICAL FIELD

The present disclosure relates to a cloud server that provides in-vehicle infotainment and a method of providing in-vehicle infotainment using the same.

### BACKGROUND

Infotainment is a compound word of information, meaning ‘information’, and entertainment, meaning ‘pleasure.’

An in-vehicle infotainment (IVI) system refers to a system in which equipment installed in a vehicle provides information related to driving, such as vehicle status and route guidance, as well as entertainment services for users.

Recently, the technology level and market for the in-vehicle infotainment are growing due to the popularization of mobile devices such as smartphones and tablet PCs, and the development of information technology (IT), beyond the combination of in-vehicle navigation, audio and video, and the Internet.

The conventional IVI system is provided with an infotainment software program built into the IVI system. Accordingly, service operators who wish to provide infotainment services within a vehicle should develop dedicated software for each IVI system installed in the vehicle, and drivers also may not select the infotainment service provided within the vehicle based on their personal preferences, and only use programs built into the IVI system, so the drivers may not actually use the infotainment services that drivers require.

### SUMMARY

An embodiment of the present disclosure can provide a cloud server that provides in-vehicle infotainment and a method of providing in-vehicle infotainment using the same.

According to an example embodiment of the present disclosure, a cloud server that provides in-vehicle infotainment can include: a virtual instance generated using a user account received from an in-vehicle infotainment (IVI) system installed in a vehicle; and when an on operation for starting the vehicle is detected by the IVI system, a cloud manager configured for receiving information on the user account from the IVI system, searching for the virtual instance including the user information matching user information included in the user account, transmitting an application list included in the searched virtual instance to the IVI system, receiving application selection information specifying at least one application among a plurality of applications included in the application list from the IVI system, executing an application corresponding to the application selection information using the searched virtual instance, and transmitting an execution screen of the application to the IVI system.

The virtual instance may include an application list that provides user information input to generate the user account and provides information on a plurality of applications that can be provided to the user through the IVI system.

The IVI system may include an input unit that receives an application execution signal including the user information and the application selection information.

The IVI system may include a display unit that outputs the application list and the execution screen of the application.

The display unit may provide each of the plurality of applications included in the application list in a form of a launcher.

The display unit may provide the execution screen of the application in a form of a window.

The IVI system may include a control unit that analyzes data measured through at least one sensor installed in the vehicle to determine whether the starting of the vehicle is turned on.

The IVI system may include a control unit that detects whether a communication connection with the user terminal is established and, when the communication connection with the user terminal is detected, determine whether the user terminal executes an application, and requests to transmit the information on the executing application.

The cloud manager may receive the information on the application being executed on the user terminal when it is determined that there is the application being executed on the user terminal by the IVI system.

The cloud manager may transmit an execution stop request and a re-execution request to an application corresponding to information on the application being executed on the user terminal.

The cloud manager may re-execute the application corresponding to the information on the application being executed on the user terminal using the searched virtual instance.

The cloud manager may re-execute the application corresponding to the information on the application being executed on the user terminal based on an execution detail of the application included in the information on the application being executed on the user terminal.

According to another example embodiment of the present disclosure, a method of providing in-vehicle infotainment using a cloud server includes: transmitting, by an in-vehicle infotainment (VI) system installed in a vehicle, information on a user account to the cloud server when an on operation for starting the vehicle is detected; searching for, by the cloud server, a virtual instance including user information matching the user information included in the received user account, and transmitting an application list included in the searched virtual instance to the IVI system; receiving, by the IVI system, application selection information specifying at least one application among a plurality of applications included in the application list, and transmitting the application selection information to the cloud server; and executing, by the cloud server, an application corresponding to the application selection information using the searched virtual instance, and transmits an execution screen of the application to the IVI system.

The method may further include: generating, by the IVI system, the user account using user information received from a user; and receiving, by the cloud server, the user account from the IVI system and generating the virtual instance.

The transmitting of the application list to the IVI system may include providing, by the IVI system, the application list to the user through a display unit.

The transmitting of the information on the user account to the cloud server may include: determining, by the IVI system, whether there is an application being executed on the user terminal when the IVI system detects a communication connection with a user terminal; requesting the user terminal to transmit the information on the executing application when it is determined that there is the application being executed on the user terminal; and transmitting the information on the executing application to the cloud server.

The transmitting of the application list to the IVI system may include: transmitting, by the cloud server, an execution stop request to an application corresponding to the information on the executing application; re-executing the application corresponding to the information on the executing application using the searched virtual instance; and transmitting an re-execution screen of the application to the IVI system.

The re-executing of the application corresponding to the information on the executing application may include re-executing, by the cloud server, the application based on an execution detail of the application included in the information on the executing application.

According to an example embodiment of the present disclosure, the applications having the same specifications as the mobile can be used in the in-vehicle infotainment system, so there is no need to develop the IVI system-only program. A variety of applications can be applied.

By executing the applications within the cloud server, the mobile or PC applications can be run on the IVI system without separately developing the IVI system-only software.

Advantages that can be achieved by an embodiment of the present disclosure are not necessarily limited to the above-described advantages. That is, other embodiments and advantages thereof can be understood by those skilled in the art to which the present disclosure pertains from the following description.

### BRIEF DESCRIPTION OF THE DRAWINGS

FIG. 1 is a diagram illustrating a process in which a cloud server communicates with a vehicle's IVI system, a user terminal, and an application according to an example embodiment of the present disclosure.

FIG. 2 is a diagram for describing an IVI system according to an example embodiment of the present disclosure.

FIG. 3 is a diagram for describing that an execution screen of the application is provided through the IVI system according to an example embodiment of the present disclosure.

FIG. 4 is a diagram for describing a cloud server according to an example embodiment of the present disclosure.

FIG. 5 is a flowchart for describing a process of executing an application in an IVI system installed in a vehicle using a cloud server according to an example embodiment of the present disclosure.

FIG. 6 is a flowchart for describing a process of re-executing an application being executed on a user terminal with an IVI system using a cloud server according to an example embodiment of the present disclosure.

FIGS. 7 and 8 are flowcharts, each for describing a method of operating a cloud server according to an example embodiment of the present disclosure.

### DETAILED DESCRIPTION OF ILLUSTRATIVE EMBODIMENTS

When it is decided that a detailed description for the known art related to example embodiments disclosed in the present specification may obscure the gist of the example embodiments disclosed in present specification, the detailed description can be omitted. Further, it can be understood that the accompanying drawings are provided to allow example embodiments of the present disclosure to be easily understood, and the spirit of the present disclosure is not necessarily limited by the accompanying drawings, and includes modifications, equivalents, and substitutions included in the spirit and the scopes of the present disclosure.

Terms including an ordinal number such as “first,” “second,” etc., may be used to describe various components, but the components are not necessarily limited to these terms. The above terms can be used solely for the purpose of distinguishing one component from another.

In the present specification, it can be understood that when one component is referred to as being “connected to” or “coupled to” another component, it may be connected or coupled directly to another component or be connected to another component with the other component interposed therebetween. On the other hand, it can be understood that when one element is referred to as being “connected directly to” or “coupled directly to” another element, it may be connected to or coupled to another element without the other element interposed therebetween.

It can be further understood that the terms “include” or “have” used in the present specification specify the presence of features, numerals, steps, operations, components, parts mentioned in the present specification, or combinations thereof, but do not preclude the presence or addition of one or more other features, numerals, steps, operations, components, parts, or combinations thereof.

The example embodiments of the present disclosure will be described in detail below with reference to the attached drawings.

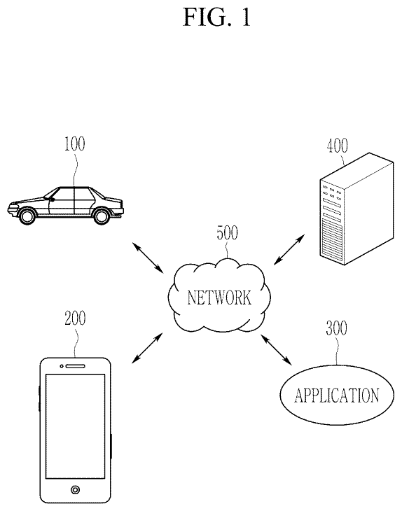

FIG. 1 is a diagram for describing a process in which a cloud server 400 according to an example embodiment of the present disclosure can communicate with an in-vehicle infotainment (IVI) system 100 installed in a vehicle, a user terminal 200, and an application 300.

Referring to FIG. 1, the cloud server 400 may communicate with the IVI system installed in the vehicle, the user terminal 200, the application 300, and a network 500.

The IVI system can be a system that provides various services to users within the vehicle in connection with the vehicle. The IVI system 100 may recognize whether the engine of the vehicle is turned on, whether users are on board, and whether a door of the vehicle is open, etc., based on data measured through at least one sensor, etc., mounted on the vehicle, and can identify vehicle location information based on GPS, etc. The IVI system 100 according to an example embodiment may provide various services to a user using the application 300 executed through the cloud server 400.

The IVI system 100 according to an example embodiment may receive user information, application execution signals, etc., from the user. The user information can be information for identifying the user and may include information (e.g., name, age, gender, etc.) on the user using the IVI system 100. The application execution signal can be a signal for executing a specific application 300 among the plurality of applications 300 usable through the IVI system 100, and may include selection information (hereinafter referred to as ‘application selection information’) for the specific application. The application selection information can refer to information on the specific application 300 selected by the user to use among the plurality of applications 300.

The IVI system 100 according to an example embodiment may generate a user account using the received user information. The IVI system 100 may transmit the information (hereinafter referred to as ‘user account information’) on the user account, the application execution signal, etc., to the cloud server 400. The IVI system 100 may receive an application list corresponding to the user account information, an execution screen of an application corresponding to the application execution signal, etc., from the cloud server 400 and provide the received application list, execution screen of application, etc., to the user.

The application list can refer to a list of applications 300 to be provided to the user through the IVI system 100, and may include some of the plurality of applications 300 that can be provided through the IVI system 100. Some of the plurality of applications 300 included in the application list may be employed by the selection of the user. Details of the applications 300 included in the application list according to an example embodiment may be configured differently for each user account. The execution screen of the application may include image information or voice information of the application 300 being executed on the cloud server 400 in response to the application selection information received by the IVI system 100.

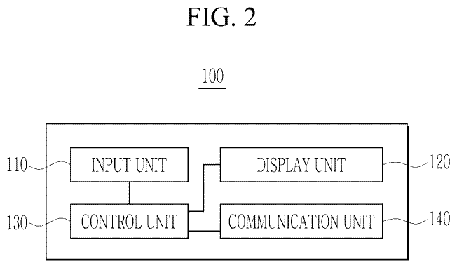

The IVI system 100 may include an input unit 110, a display unit 120, a control unit 130, a communication unit 140, etc., and the configuration of the IVI system 100 is described in detail in FIG. 2.

The user terminal 200 may be a device capable of communicating with the IVI system 100 installed in the vehicle. For example, the user terminal 200 may be a communicable computer, a tablet PC, a wireless phone, a mobile phone, a smart phone, a smart watch, a smart glass, a portable game console, a navigation device, etc.

When the user terminal 200 according to an example embodiment is in a state capable of communicating with the IVI system 100, the user may transmit the information on the executing application to the IVI system 100 through the user terminal 200. The information on the executing application may include whether the application 300 is executing, the type of executing applications 300, and the execution details. The IVI system 100 may receive whether the application 300 is executing from the user terminal 200 and determine whether there is the application 300 being executed on the user terminal 200.

For example, when a user boards a vehicle and turns on the engine of the vehicle while executing the specific application 300, the IVI system 100 may establish a communication connection with the user terminal 200. Thereafter, the IVI system 100 may determine whether the application 300 is being executed on the communication-connected user terminal 200, and when it is determined that the application is being executed on the user terminal 200, it may transmit a signal requesting to transmit the information on the executing application to the user terminal 200. Thereafter, the user terminal 200 may transmit to the IVI system 100 whether the application 300 is executing, the type of executing applications 300, and the execution details, etc., according to the request of the IVI system 100.

The application 300 can be a variety of application software developed for user convenience in operating systems such as computers, smartphones, or tablet PCs. For example, the application 300 may be software for providing various types of content such as video streaming, games, traffic information, logistics information, and product information to users. However, the type of applications 300 is not necessarily limited thereto, and the application 300 according to an example embodiment of the present disclosure may include all the applications 300 developed and used by various previously known methods. FIG. 1 illustrates one application 300, but the number of applications 300 with which the cloud server 400 may communicate is not limited thereto, and the number of applications 300 according to an example embodiment of the present disclosure may be at least one.

The application 300 according to an example embodiment may perform the execution of the application within the cloud server 400, the transmission of the execution screen of the application, etc., after receiving permission to use the cloud server 400 from the operator of the cloud server 400. For example, an owner or developer of the application 300 may provide the application 300 service to the IVI system 100 using the cloud server 400 under the condition of paying a predetermined usage fee for a predetermined period of time through a contract with the operator of the cloud server 400, etc. That is, as the application 300 according to an example embodiment is executed within the cloud server 400, there can be no need to separately develop the IVI system 100-only software, so the application 300 to be provided by the IVI system 100 can be easily added.

The cloud server 400 may generate a virtual instance for each user account received from the IVI system 100. The cloud server 400 may execute the specific application 300 within the cloud server 400 using the virtual instance, according to a request to execute the specific application 300 received from the IVI system 100. The cloud server 400 may transmit the execution screen of the application 300 to the IVI system 100 and/or the user terminal 200. For example, the cloud server 400 may transmit the execution screen of the application 300 to the IVI system 100 and/or the user terminal 200. As another example, the cloud server 400 may simultaneously transmit the execution screen of the application 300 to the IVI system 100 and the user terminal 200. The user may be simultaneously provided with the execution screen of the application 300 through the IVI system 100 and the user terminal 200.

According to an example embodiment, the cloud server 400 may transmit the execution screen of the application 300 to the plurality of IVI systems 100. For example, the cloud server 400 may simultaneously transmit the execution screen of the application being transmitted to the IVI system 100 installed in a specific vehicle to the IVI system 100 installed in another vehicle. Accordingly, the user may share the application execution screen with other people through the IVI system 100.

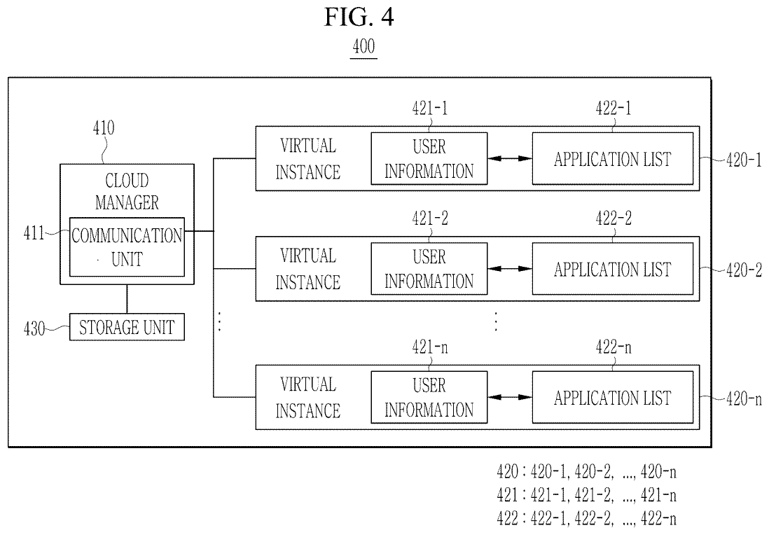

The cloud server 400 may include a cloud manager 410, a virtual instance 420, and a storage unit 430, and the detailed configuration of the cloud server 400 is described in FIG. 4.

The network 500 can refer to a connection structure that enables information exchange between respective nodes such as the IVI system 100, the user terminal 200, the application 300, and the cloud server 400. For example, the network 500 may include a local area network (LAN), a wide area network (WAN), the Internet (WWW: World Wide Web), a wired and wireless data communication network, a telephone network, a wired and wireless television communication network, etc. For example, the wireless data communication network can include, but is not limited thereto, 3G, 4G, 5G, 3rd Generation Partnership Project (3GPP), Long Term Evolution (LTE), World Interoperability for Microwave Access (WIMAX), Wi-Fi, Bluetooth communication, infrared communication, ultrasonic communication, visible light communication (VLC), LiFi, etc.

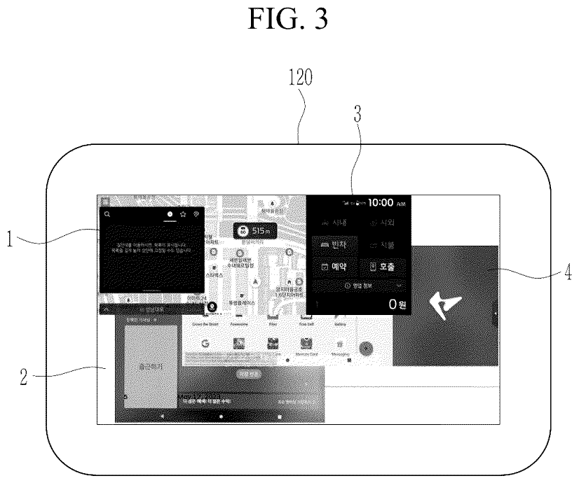

FIG. 2 is a diagram for describing the IVI system 100 according to an example embodiment of the present disclosure. FIG. 3 is a diagram for describing that an execution screen of the application can be provided through the IVI system 100 according to an example embodiment of the present disclosure.

Referring to FIG. 2, the IVI system 100 according to an example embodiment of the present disclosure may include the input unit 110, the display unit 120, the control unit 130, and the communication unit 140, any combination of or all of which may be in plural or may include plural components thereof.

The input unit 110 can be configured to receive input from a user and may receive user information and application execution signals. The input unit 110 according to an example embodiment may include, but is not limited thereto, a key pad, a touch pad, a jog wheel, a jog switch, etc. The input unit 110 may include a microphone. The microphone may be configured to receive audio (e.g., voice command) from the user. The application execution signal can be a signal for selecting and executing one of the plurality of applications 300, and the user may input an application execution signal including application selection information by clicking or touching one of the plurality of applications 300. The plurality of applications 300 may be provided to the user in the form of a launcher through the display unit 120.

The display unit 120 can be configured to provide the information to the user, may output video signals and/or audio signals, and may include a display and/or an audio output unit, but is not limited thereto. The display unit 120 may output the application list received from the cloud server 400 and the execution screen of the application. The display unit 120 according to an example embodiment may provide the plurality of applications 300 included in the application list, respectively, in the form of the launcher. As illustrated in FIG. 3, the display unit 120 may provide the execution screen of the application being executed on the cloud server 400 in the form of windows 1, 2, 3, and 4. According to an example embodiment, there may be a plurality of windows provided within the display unit 120, and the plurality of windows 1, 2, 3, and 4 may be provided within the display unit 120 in an overlapping state with each other. The number of windows 1, 2, 3, and 4 provided in the display unit 120 can correspond to the number of applications 300 being executed in the cloud server 400.

The control unit 130 can be configured to control the operation of the IVI system 100 and may generate the user account using the user information. The user account can be generated for the user to use the IVI system 100, and may include the user information. The control unit 130 may transmit the generated user account to the cloud server 400 and store the user account information in the cloud server 400. The IVI system 100 according to an example embodiment may generate multiple user accounts.

The control unit 130 may determine whether the engine of the vehicle is turned on by analyzing data measured through sensors, etc. When it is determined that the engine of the vehicle is turned on, the control unit 130 may transmit the user account to the cloud server 400.

The control unit 130 may control to provide information received from the cloud server 400 through the display unit 120. For example, the control unit 130 may receive the application list from the cloud server 400 and control the plurality of applications 300 included in the received application list to be provided in the form of the launcher within the display unit 120. As another example, the control unit 130 may receive the execution screen of the application from the cloud server 400 and control the execution screen of the application to be provided in a window form within the display unit 120.

The control unit 130 may detect whether the communication connection with the user terminal 200 is established. When the communication connection with the user terminal 200 is detected, the control unit 130 may transmit a signal requesting whether the user terminal 200 is executing the application and a signal requesting to transmit the information on the executing application. When it is determined that there is the application 300 being executed on the communication-connected user terminal 200, the control unit 130 may receive the information on the executing application from the user terminal 200 and transmit the received information to the cloud server 400. The information on the executing application may include the type, execution details, etc., of the application 300 being executed on the user terminal 200.

The control unit 130 may control communication with the cloud server 400, the user terminal 200, the application 300, etc., through the network 500.

The communication unit 140 can be configured to communicate with the user terminal 200, the cloud server 400, the application 300, etc., through the network 500. The communication unit 140 may transmit the user account, the application selection information, etc., to the cloud server 400, receive the execution screen of the application, and receive the information on the application being executed from the user terminal 200.

FIG. 4 is a diagram for describing the cloud server 400 according to an example embodiment of the present disclosure.

Referring to FIG. 4, the cloud server 400 may include a cloud manager 410, a virtual instance 420, and a storage unit 430.

The cloud manager 410 may control the overall operation of the virtual instance 420. For example, the cloud manager 410 may generate, terminate, and manage the virtual instances 420. The cloud manager 410 according to an example embodiment may receive the user account from the IVI system 100 to generate the virtual instance 420.

The virtual instances 420 (420-1, 420-2, . . . , 420-n) can be used to execute the application 300 and may include user information 421 (421-1, 421-2, . . . , 421-n) and an application list 422 (422-1, 422-2, . . . , 422-n). The user information 421 included in the virtual instance 420 can correspond to the user information included in the user account used to the virtual instance 420. The application list included in the virtual instance 420 according to an example embodiment may include some of the plurality of applications 300 that can be provided to the user through the cloud server 400. Some of the plurality of applications 300 included in the application list may be employed by the selection of the user.

The virtual instance 420 according to an example embodiment may be a virtual machine generated by the cloud manager 410. For example, the virtual instance 420 may be a virtual machine equipped with virtual computing resources and an operating system. The virtual computing resources of the virtual instance 420 may be allocated with some of the computing resources of at least one cloud server 400 that provides cloud services. The virtual instance 420 may use virtual computing resources to execute the application 300 requested from the cloud manager 410.

The cloud manager 410 may receive the user account from the IVI system 100. The cloud manager 410 may receive the user account when the IVI system 100 determines that the engine of the vehicle is turned on. The cloud manager 410 may search for the virtual instance 420 including the user information 421 that matches the user information included in the user account among the plurality of virtual instances 420-1, 420-2, . . . , 420-n generated in the cloud server 400.

The cloud manager 410 may transmit the application list included in the searched virtual instance 420 to the IVI system 100 and provide the application list to the user. Thereafter, the cloud manager 410 may receive the application execution signal including the application selection information from the IVI system 100. The cloud manager 410 may transmit an execution request to the application 300 corresponding to the application execution signal.

The cloud manager 410 may execute the application 300 within the cloud server 400 using the virtual instance 420. The virtual instance 420 that the cloud manager 410 uses to execute the application 300 can include the user information 421 that matches the user information included in the user account. The cloud manager 410 may transmit the execution screen of the application 300 being executed through the searched virtual instance 420 to the IVI system 100 and provide the execution screen of the application 300 to the user.

When the communication connection between the IVI system 100 and the user terminal 200 is detected by the IVI system 100, the cloud manager 410 may receive, from IVI system 100, the information on whether there is the application 300 being executed on the user terminal 200 and the information on the executing application.

The cloud manager 410 may transmit an execution stop request and a re-execution request to the application 300 currently being executed on the user terminal 200. For example, the cloud manager 410 may transmit the execution stop request to the application and stop the application being executed on the user terminal 200. As another example, the cloud manager 410 may transmit the re-execution request to the application and re-execute the application within the cloud server 400. The cloud manager 410 may re-execute the application 300 within the cloud server 400 using the virtual instance 420. The virtual instance 420 that the cloud manager 410 uses to re-execute the application 300 can include the user information 421 that matches the user information included in the user account.

The cloud manager 410 according to an example embodiment may re-execute the application 300 based on the execution details of the application 300 included in the information on the executing application. For example, the cloud server 400 may re-execute the application 300 from the time when the application 300 stops on the user terminal 200.

The cloud manager 410 may transmit the re-execution screen of the application 300 being re-executed through the searched virtual instance 420 to the IVI system 100 and provide the re-execution screen of the application 300 to the user.

The cloud manager 410 according to an example embodiment may include a communication unit 411. In FIG. 4, the communication unit 411 is illustrated as being included inside the cloud manager 410, but the position of the communication unit 411 is not limited thereto, and the communication unit 411 can be implemented outside the cloud manager 410. The communication unit 411 may communicate with the IVI system 100, the user terminal 200, the application 300, etc., through the network 500.

The storage unit 430 may store the information received by the cloud server 400 from the IVI system 100, the information generated by the cloud server 400, etc. For example, the storage unit 430 may store the user information, the application list, the application selection information, and the information on the executing applications that are received from the IVI system 100. As another example, the storage unit 430 may store the information on the virtual instance 420 generated by the cloud manager 410, the information on the virtual instance 420 removed from the cloud manager 410, and the application 300 execution information, the application 300 re-execution information, etc.

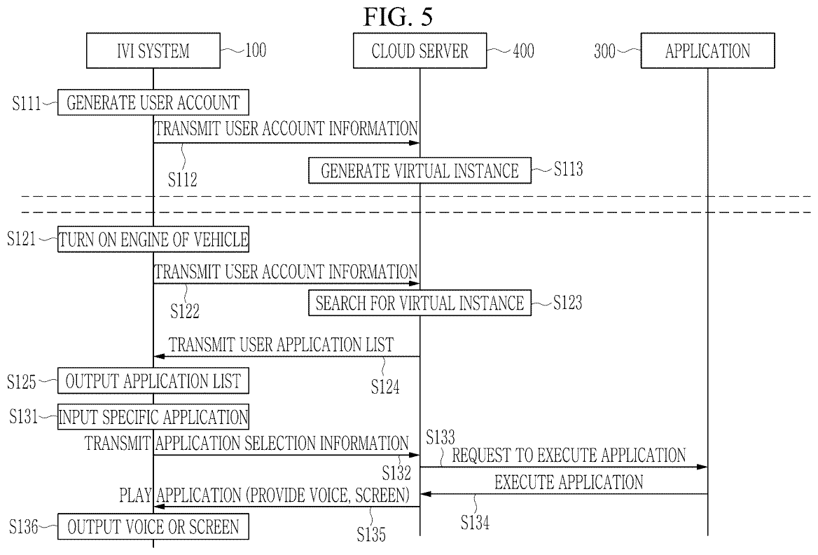

FIG. 5 is a flowchart for describing a process of executing the application 300 in the IVI system 100 installed in the vehicle using the cloud server 400 according to an example embodiment.

Referring to FIG. 5, a process in which the application 300 is executed on the cloud server 400 according to an example embodiment and a process in which the execution screen of the application 300 is provided to the user through the IVI system 100 are illustrated.

The IVI system 100 may receive the user information to generate the user account (operation S111), and transmit the generated user account information to the cloud server 400 (operation S112).

The cloud server 400 may generate the virtual instance using the user account information received from the IVI system 100 (operation S113). The generated virtual instance may be recorded in the storage unit 430 of the cloud server 400.

The user may board the vehicle and turn on the engine of the vehicle (operation S121). The IVI system 100 may detect that the engine of the vehicle is turned on and transmit the user account information generated in operation S111 to the cloud server 400 (operation S122).

The cloud server 400 may search for the virtual instance including the user information that matches the user information included in the user account information received from the IVI system 100 (operation S123).

The cloud server 400 may transmit the application list included in the searched virtual instance to the IVI system 100 (operation S124). The IVI system 100 may output the received application list through the display unit 120 and provide the received application list to the user (operation S125).

The user may select at least one application from among the plurality of applications 300 included in the application list provided through the IVI system 100, and input the selected specific application to the IVI system 100 (operation S131).

The IVI system 100 may transmit the information (i.e., application selection information) on the specific application selected by the user to the cloud server 400 (operation S132).

The cloud server 400 may transmit the application execution request to the application 300 corresponding to the application selection information (operation S133).

The application 300 may execute the application within the cloud server 400 according to the application execution request received from the cloud server 400 (operation S134). The application being executed within the cloud server 400 may be executed using the virtual instance searched in operation S123.

The cloud server 400 may transmit the execution screen of the application being executed within the cloud server to the IVI system 100 (operation S135). The IVI system 100 may output the voice and/or image according to the information received from the cloud server 400 and provide the execution screen of the application to the user (operation S136).

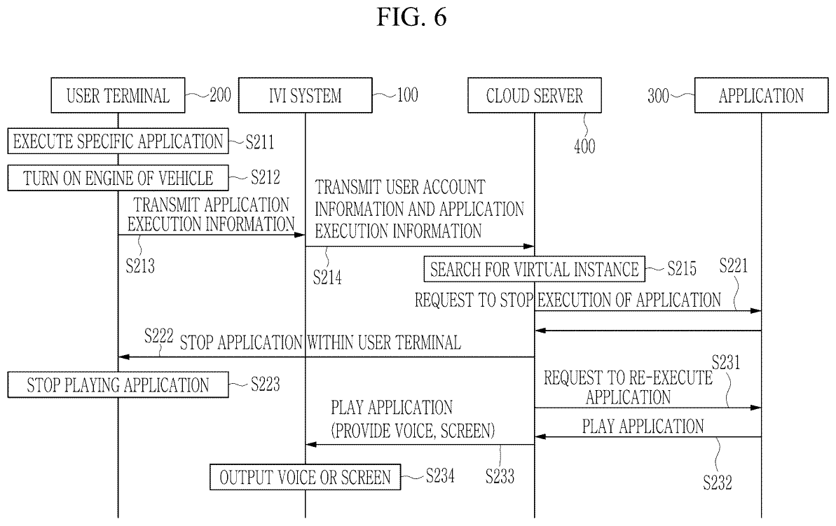

FIG. 6 is a flowchart for describing a process of re-executing the application 300 being executed on the user terminal 200 with an IVI system using the cloud server 400 according to an example embodiment.

Referring to FIG. 6, a process of switching the execution subject of the application 300 from the user terminal 200 to the IVI system 100 according to the user boarding the vehicle and the on operation of the engine of the vehicle by using the cloud server 400 according to an example embodiment is shown.

The user may board the vehicle while executing the specific application through the user terminal 200 (operation S211).

The user may turn on the engine of the vehicle after boarding the vehicle (operation S212). The communication between the user terminal 200 and the IVI system 100 may be connected. The IVI system 100 may detect the on operation of the engine of the vehicle or the communication connection with the user terminal, and determine whether there is the application 300 being executed on the user terminal 200. When it is determined that there is the application 300 being executed on the user terminal 200, the IVI system 100 may transmit a signal requesting to transmit the information on the executing application to the user terminal 200.

The user terminal 200 may transmit the information on the application that the user is executing to the IVI system 100 (operation S213). The user terminal 200 may transmit to the IVI system 100 whether the application 300 is executing, the type of executing applications 300, and the execution details, etc., according to the request of the IVI system 100.

When the on operation of the engine of the vehicle and the communication connection with the user terminal 200 are detected, the IVI system 100 may transmit the user account information and the information on the executing application to the cloud server 400 (operation S214). The information on the executing application may include whether the application 300 is executing, the type of executing applications 300, and the execution details.

The cloud server 400 may search for the virtual instance including the user information that matches the user information included in the user account received from the IVI system 100 (operation S215).

The cloud server 400 may transmit the execution stop request to the application 300 corresponding to the information on the executing application received from the IVI system 100 (operation S221).

The application 300 may stop the application being executed on the user terminal 200 according to the application execution stop request received from the cloud server 400 (operation S222). The application 300 may directly transmit a control signal to stop the execution of the application within the user terminal 200 to the user terminal 200 or may transmit the control signal to the user terminal 200 through the cloud server 400.

The user terminal 200 may stop playing the executing application under the control of the application 300 or the cloud server 400 (operation S223).

The cloud server 400 may request application re-execution for the application 300 corresponding to the information on the executing application (operation S231).

The application 300 may re-execute the application within the cloud server 400 according to the application re-execution request received from the cloud server 400 (operation S232). The application 300 executed within the cloud server 400 may be re-executed using the virtual instance searched in operation S215.

The cloud server 400 may transmit the execution screen of the application 300 being re-executed within the cloud server 400 to the IVI system 100 (operation S233).

The IVI system 100 may output the voice and/or image according to the information received from the cloud server 400 and provide the re-execution screen of the application to the user (operation S234).

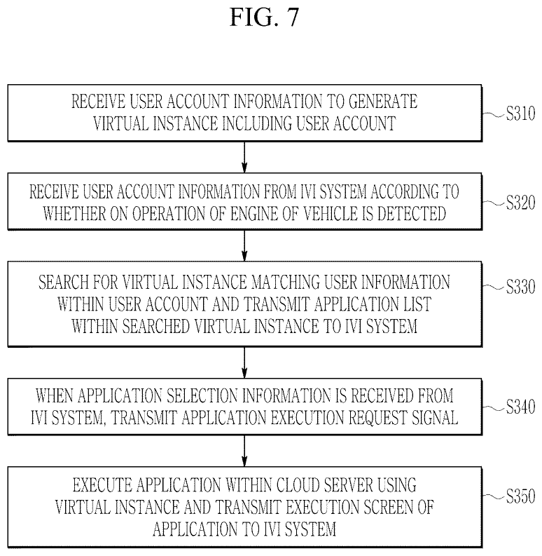

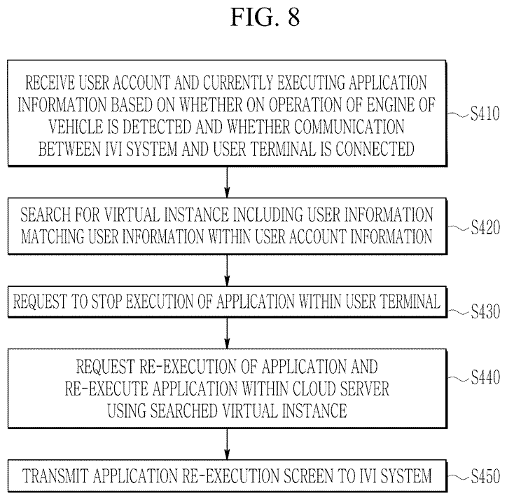

FIGS. 7 and 8 are flowcharts for describing a method of operating a cloud server according to an example embodiment of the present disclosure.

Referring to FIG. 7, a method of operating a cloud server according to an example embodiment of the present disclosure can include generating the virtual instance (operation S310), receiving the user account information (operation S320), searching for the virtual instance and transmitting the application list (operation S330), receiving the application selection information (operation S340), and executing the application and transmitting the execution screen (operation S350).

In the generating of the virtual instance (operation S310), the cloud server 400 may receive the user account information from the IVI system 100 to generate the virtual instance. The user account is generated by the IVI system 100 and may be generated using the user information received from the user.

In the receiving of the user account information (operation S320), when the cloud server 400 determines that the engine of the vehicle is turned on by the IVI system 100, the cloud server 400 may receive the user account information from the IVI system 100.

In the searching for of the virtual instance and transmitting of the application list (operation S330), the cloud server 400 may search for the virtual instance including the same user information as the user information included in the user account information. The cloud server 400 may transmit the application list included in the searched virtual instance to the IVI system 100.

In the receiving of the application selection information (operation S340), the cloud server 400 may receive the application execution signal including the application selection information from the IVI system 100. The application selection information can refer to information that specifies at least one of the plurality of applications 300 included in the application list. The cloud server 400 may transmit the application execution request to the application 300 corresponding to the application selection information (operation S133).

In the executing of the application and transmitting of the execution screen (operation S350), the cloud server 400 may execute the application 300 corresponding to the application selection information within the cloud server 400 using the virtual instance. The cloud server 400 may transmit the execution screen of the application 300 to the IVI system 100 and provide the execution screen to the user.

Referring to FIG. 8, a method of operating a cloud server according to an example embodiment of the present disclosure can include receiving the user account and the application information (operation S410), searching for the virtual instance (operation S420), stopping the application execution (operation S430), re-executing the application (operation S440), and transmitting the execution screen (operation S450).

In the receiving of the user account and application information (operation S410), when the cloud server 400 determines that the engine of the vehicle is turned on by the IVI system 100, the cloud server 400 may receive the user account information from the IVI system 100. When the communication connection between the IVI system 100 and the user terminal 200 is detected by the IVI system 100, the cloud server 400 may receive, from IVI system 100, the information on whether there is the application 300 being executed on the user terminal 200 and the information on the executing application.

In the searching for of the virtual instance (operation S420), the cloud server 400 may search for the virtual instance including the same user information as the user information included in the user account information.

In the stopping of the application execution (operation S430), the cloud server 400 may transmit the execution stop request to the application 300 corresponding to the information on the executing application received from the IVI system 100. Accordingly, the application 300 may stop the application being executed on the user terminal 200.

In the re-executing of the application (operation S440), the cloud server 400 may re-execute the application 300 corresponding to the information on the executing application received from the IVI system 100 within the cloud server 400 using the virtual instance. The cloud server 400 may re-execute the application 300 based on the execution details of the application 300 included in the information on the executing application. For example, the cloud server 400 may re-execute the application 300 from the time when the application 300 stops on the user terminal 200.

In the transmitting of the execution screen (operation S450), the cloud server 400 may transmit the re-execution screen of the application 300 to the IVI system 100 and provide the execution screen to the user.

Any of the above-described methods can be written as a program that may be executed on a computer, and can be implemented in one or more general-purpose digital computers that operate the programs using a computer-readable recording medium. The computer-readable recording medium (storage medium) may include a magnetic storage medium such as ROM, RAM, USB, floppy disk, or hard disk, or a storage medium such as an optical readable medium such as CD-ROM or DVD, or any combination thereof, for example.

It can be interpreted that the scopes of the present disclosure can be defined by the following claims rather than the above-mentioned detailed description and all modifications or alterations deduced from the meanings, the scopes, and equivalences of the claims can be included in the scopes of the present disclosure.

What is claimed is:

1. A cloud server configured to provide in-vehicle infotainment, the cloud server comprising a cloud manager, wherein the cloud server is configured to generate a virtual instance using a user account received from an in-vehicle infotainment (IVI) system installed in a vehicle, and wherein, in response to
an on operation for starting the vehicle being detected by the IVI system, the cloud manager is configured to:
receive information on the user account from the IVI system,
search for the virtual instance including user information matching the user account,
transmit an application list included in the virtual instance to the IVI system,
receive application selection information specifying at least one application among a plurality of applications included in the application list from the IVI system,
execute a selected application corresponding to the application selection information using the virtual instance, and
transmit an execution screen of the selected application to the IVI system.

2. The cloud server of claim 1, wherein the virtual instance includes
the application list, and wherein the application list includes user information input to generate the user account and application list information on the plurality of applications provided to a user through the IVI system.

3. The cloud server of claim 1, wherein the cloud manager is further configured to
receive application execution information regarding a first application already being executed on a user terminal of the IVI system.

4. The cloud server of claim 3, wherein the cloud manager is further configured to
transmit an execution stop request and a re-execution request for the first application.

5. The cloud server of claim 3, wherein the cloud manager is further configured to
re-execute the first application using the virtual instance.

6. The cloud server of claim 3, wherein the cloud manager is further configured to
re-executes the first application based on an execution detail of the first application included in the application execution information about the first application.

7. A method of providing in-vehicle infotainment, the method comprising:
transmitting, by an in-vehicle infotainment (IVI) system installed in a vehicle, information on a user account to a cloud server in response to an on operation for starting the vehicle being detected;
searching for, by the cloud server, a virtual instance including user information matching the user account;
transmitting, by the cloud server, an application list included in the virtual instance to the IVI system;
receiving, by the IVI system, application selection information specifying at least one selected application among a plurality of applications included in the application list;
transmitting, by the IVI system, the application selection information to the cloud server;
executing, by the cloud server, the at least one selected application corresponding to the application selection information using the virtual instance; and
transmitting, by the cloud server, an execution screen of the at least one selected application to the IVI system.

8. The method of claim 7, further comprising:
generating, by the IVI system, the user account using user information received from a user;
receiving, by the cloud server, the user account from the IVI system; and
generating, by the cloud server, the virtual instance.

9. The method of claim 7, further comprising:
providing, by the IVI system, the application list to the user through a display unit.

10. The method of claim 7, further comprising:
determining, by the IVI system, whether there is a first application already being executed on a user terminal in response to the IVI system detecting a communication connection with a user terminal;
requesting the user terminal to transmit application execution information about the first application, in response determining that the first application is already being executed on the user terminal; and
transmitting the application execution information about the first application to the cloud server.

11. The method of claim 10, further comprising:
transmitting, by the cloud server, an execution stop request for the first application;
re-executing the first application using the virtual instance; and
transmitting a re-execution screen of the first application to the IVI system.

12. The method of claim 11, wherein the re-executing of the first application includes re-executing, by the cloud server, the first application based on an execution detail of the first application included in the application execution information.

13. An infotainment system comprising:
an in-vehicle infotainment (IVI) system installed in a vehicle; and
a cloud server including a cloud manager, wherein the IVI system and the cloud server are configured to communicate with each other, wherein the cloud server is configured to generate a virtual instance using a user account received from the IVI system, and wherein in response to an on operation for starting the vehicle being detected by the IVI system, the cloud manager is configured to:
receive information on the user account from the IVI system,
search for the virtual instance including user information matching the user account,
transmit an application list included in the virtual instance to the IVI system,
receive application selection information specifying at least one application among a plurality of applications included in the application list from the IVI system,
execute a selected application corresponding to the application selection information using the virtual instance, and
transmit an execution screen of the selected application to the IVI system.

14. The infotainment system of claim 13, wherein the IVI system includes an input unit configured to receive an application execution signal including the user information and the application selection information.

15. The infotainment system of claim 13, wherein the IVI system includes a display unit configured to output the application list and the execution screen of the selected application.

16. The infotainment system of claim 15, wherein the display unit is configured to provide the plurality of applications included in the application list in a form of a launcher.

17. The infotainment system of claim 15, wherein the display unit is configured to provide the execution screen of the selected application in a form of a window.

18. The infotainment system of claim 13, wherein the IVI system includes a control unit configured to analyze data measured through at least one sensor installed in the vehicle to determine whether an engine of the vehicle is turned on.

19. The infotainment system of claim 13, wherein the IVI system includes a control unit configured to:
detect whether a communication connection with a user terminal is established, and
in response to the communication connection with the user terminal being detected, determine whether the user terminal already executes a first application, and request to transmit application execution information about the first application.
